(19) United States
(12) Patent Application Publication
(10) Pub. No.: US 2010/0107892 A1
(43) Pub. Date: May 6, 2010

(54) ADJUSTABLE TEMPERATURE ELECTROTHERMAL ROASTER

(75) Inventors: Yaohong Yeh, Fujian (CN); Chunlei Zhang, Fujian (CN)

Correspondence Address: RABIN & Berdo, PC, 1101 14TH STREET, NW, SUITE 500, WASHINGTON, DC, 20005, US

(73) Assignee: TSANN KUEN (CHINA) ENTERPRISE CO., LTD., Fujian (CN)

(21) Appl. No.: 12/532,747

(22) PCT Filed: Apr. 2, 2008
(86) PCT No.: PCT/CN08/00666

§ 371 Date: Sep. 23, 2009

(30) Foreign Application Priority Data
Mar. 23, 2007 (CN) 200710008744.8

(51) Int. Cl. A47J 37/06; H05B 1/02

(52) U.S. Cl. 99/333; 99/332; 99/442

(57) ABSTRACT

An adjustable temperature electrothermal grill is provided. The present invention discloses a grill comprising a grill pan provided with a heating member, a temperature sensing member for sensing temperature of the grill pan. The heating member and the temperature sensing member are connected to a control circuit. The temperature sensing member provides the temperature signal of the grill pan to the control circuit. The grill further comprises a thermoregulation member and a high temperature switch. The thermoregulation member and the high temperature switch provide the temperature control signal to the control circuit. The control circuit controls the power on/off of the heating member based on the temperature signal of the grill pan and the temperature control signal.

### TECHNOLOGY FIELD

This invention relates to grill, especially to a kind of adjustable temperature electrothermal grill.

### BACKGROUND OF THE INVENTION

In existing technology, there are two common heating methods in the grill, one is the use of electric heating tube, the other is the use of gas heating. The advantage of the gas-heated grill is fast heating, but the temperature is not easy to be controlled; while the advantage of the electric heating tube -heated grill is slow heating, but the temperature is easy to be controlled.

The surface of high-end steak is required to be slightly burned, while the interior is warm and full of gravy. This requires that firstly the grill pan is heated by strong fire so as to reach a higher temperature, so that the surface of steak is slightly burned, the burned surface surrounds the inner gravy to prevent the gravy from vaporizing, and then the grill pan is heated by slow fire so as to cook the interior of the steak. The said disadvantage exists in the gas-heated grill and the electric heating tube-heated grill, it is difficult to achieve this effect.

Regarding an adjustable temperature electrothermal grill, we can rotate the knob by hand to adjust the temperature to the highest temperature, then rotate the knob by hand to adjust the temperature to the lower temperature after a period of time to realize the above mentioned grilling mode, but this operation is inconvenience to users, because users do not necessarily aware of such a grilling mode, do not know the accurate so-called high-temperature.

### SUMMARY OF THE INVENTION

The present invention is to provide an adjustable temperature electrothermal grill, the main purpose is to overcome the disadvantage exists in the existing electrothermal grill that is difficult to cook flesh food whose surface is slightly burned and the interior is full of gravy, and the operation is inconvenience to users.

The present invention adopts the following technical solution: A grill comprises: a grill pan provided with a heating member for heating said grill pan;

a control circuit;

a temperature sensing member for sensing temperature of the grill pan and providing the temperature signal of said grill pan to said control circuit; wherein said heating member and said temperature sensing member are connected to said control circuit;

a thermoregulation member and a high temperature switch for providing the temperature control signal to said control circuit;

wherein said control circuit controls the power on/off of said heating member based on the temperature signal of the grill pan and the temperature control signal.

Said adjustable temperature electrothermal grill, the temperature of the grill pan can reach any temperature between 245° C. and 275° C. based on the temperature control signal provided by said high temperature switch, the temperature of the grill pan can reach 260° C. based on the temperature control signal provided by said high temperature switch, the duration for heating the grill pan based on the temperature control signal provided by said high temperature switch is 2 minutes, the grill further comprising a time regulation button for providing time control signal to said control circuit, the control circuit controls the heating member to be connected with or disconnected from a power based on the time control signal.

Said adjustable temperature electrothermal grill, the control circuit comprises a power supply unit and a control unit, a commutated voltage transformation circuit disposed on said power supply unit for providing the DC current to the control unit and said heating member, said control unit comprising a micro-processing chip, a button circuit and a high-power drive circuit, said button circuit is connected between said micro-processing chip and said thermoregulation member and the high temperature switch, said high-power drive circuit is connected between said micro-processing chip and said heating member, and is connected to a DC output terminal of the commutated voltage transformation circuit, said temperature sensing member is connected to the micro-processing chip.

The grill further comprising a display device, a display driver circuit is set in said control unit, said display driver circuit is connected between the display device and the micro-processing chip.

The grill further comprising a mode switch button for switching the temperature value or timing value displayed on the display device.

As mentioned above, compared with existing technologies, the present invention has the following advantages: You can control the grill pan to reach a fixed high temperature by opening the high temperature switch, and then put the flesh food, after a certain period of time, the surface of the flesh food is slightly burned, the temperature of the grill pan falls to a lower temperature, at this time, we can adjust the temperature of the grill pan by the thermoregulation member, and cook the food slowly so as to cook the interior of the flesh food, and the interior is full of gravy.

### BRIEF DESCRIPTION OF THE DRAWINGS

FIG. 1 is a three-dimensional diagram of the grill based on the present invention;

FIG. 2 is a three-dimensional exploded view of the grill based on the present invention;

FIG. 3 is a circuit functional block diagram of the present invention.

### DESCRIPTION OF THE PREFERRED EMBODIMENTS

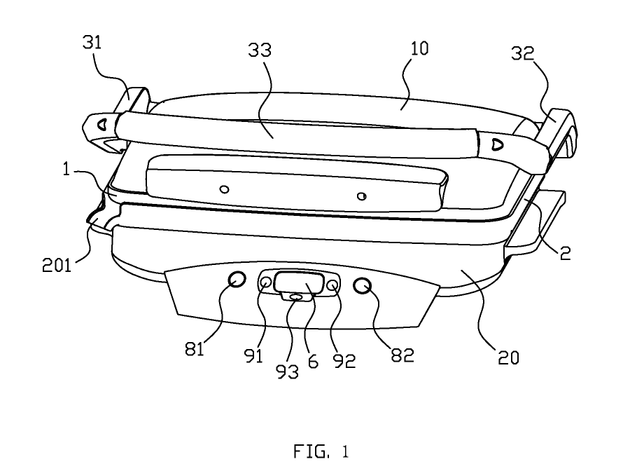

The embodiments based on the present invention will be explained by referring the FIGS. 1-3.

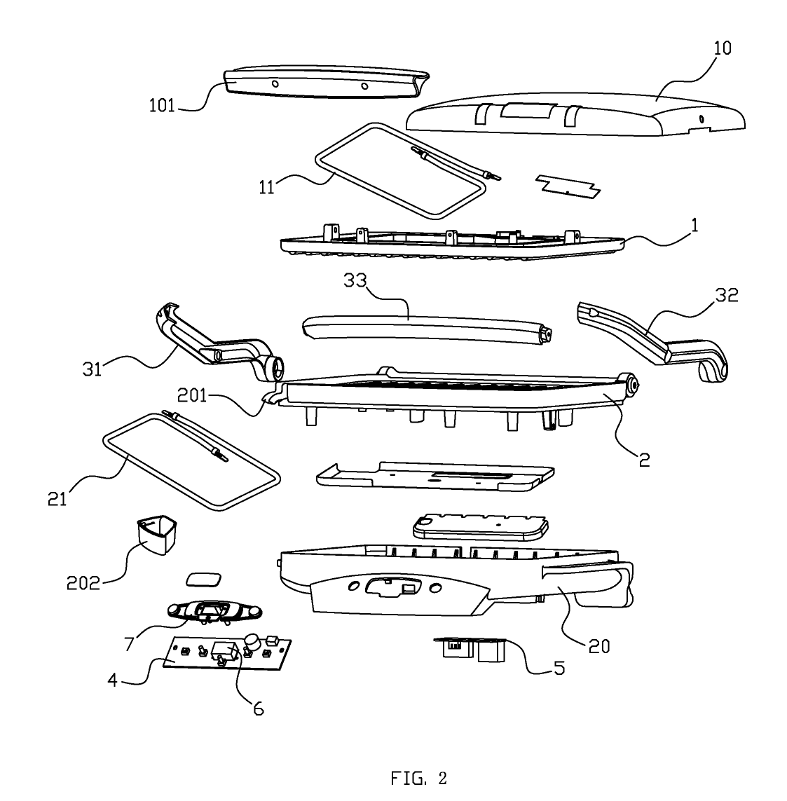

Referring to FIG. 1 and FIG. 2, the grill, comprises an upper grill pan 1, a lower grill pan 2, an upper steel shell 10 positioned above the upper grill pan 1, a lower bakelite shell 20 positioned below the lower grill pan 2, a left rod 31 and a right rod 32 are respectively pivotally connected to the back end of two sides of the lower grill pan 2, the front portions of the left rod 31 and the right rod 32 are connected to the two ends of a handle 33 by screw, the middle portions of two sides of said upper grill pan 1 is pivotally connected to the middle portions of two inners of the left rod 31 and the right rod 32. Thereby, in grilling process, the distance between the upper grill pan 1 and the lower grill pan 2 may be adaptive to the size and shape of food.

Referring to FIG. 2, a heating tube 11 is positioned above the upper grill pan 1, a heating tube 21 is positioned below the lower grill pan 2. A power supply unit 5 and a control unit 4 is provided in the lower bakelite shell 20, the display device 6 protruding from the front of the lower bakelite shell 20 is positioned in the control unit 4, a button plate 7 is positioned in the front of the lower bakelite shell 20, referring to FIG. 1, a mode switch button 81, a high temperature switch 82 and thermoregulation/time regulation buttons 91, 92, a power switch 93. the mode switch button 81 for switching the temperature value or timing value displayed on the display device 6, thermoregulation/time regulation buttons 91, 92, which are used for regulating the needed temperature of the grill pan or the needed grilling time, this temperature is commonly low, the high temperature switch 82 is used for setting a certain high temperature value so as to the temperature of the grill pan can reach said certain high temperature.

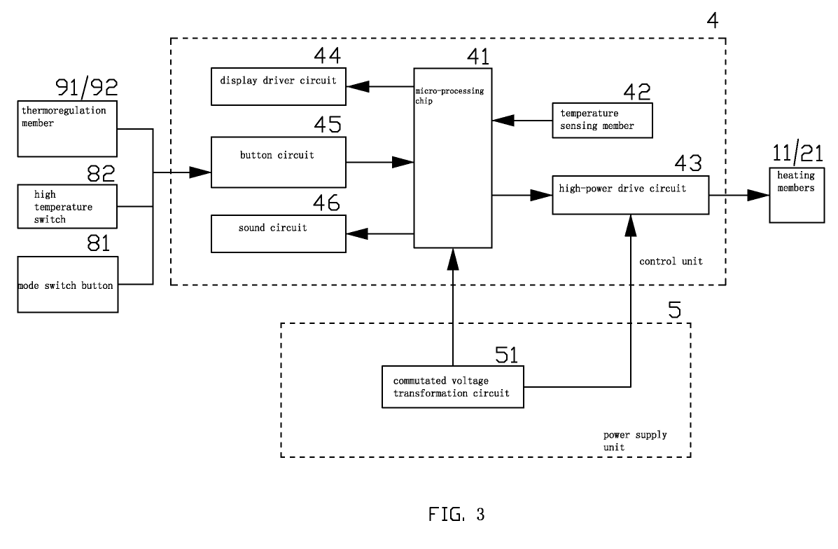

Referring to FIG. 3, a temperature sensing member 42 for sensing temperature of the lower grill pan 2 is provided in the lower grill pan 2, said temperature sensing member 42 is not illustrated in the FIG. 2, but illustrated in the FIG. 3. The heating members 11, 21 and the temperature sensing member 42 are connected to a control circuit 4, the temperature sensing member 42 for providing the temperature signal of said grill pan to said control circuit, said mode switch button 81, high temperature switch 82 and thermoregulation/time regulation buttons 91, 92 are connected to said control circuit, the high temperature switch 82 and thermoregulation/time regulation buttons 91, 92 for providing the temperature control signal to said control circuit, the control circuit controls the power on/off of said heating members 11, 21 based on the temperature signal of the grill pan and the temperature control signal, and the actual temperature of the grill pan can be controlled within certain range.

Referring to FIG. 2-3, the control circuit comprises a power supply unit 5 and a control unit 4, a commutated voltage transformation circuit 51 disposed on said power supply unit 5 for providing the DC current to the control unit 4 and the heating members 11, 21, said control unit 4 comprising a micro-processing chip 41, a button circuit 45, a high-power drive circuit 43, a display driver circuit 44 and a sound circuit 46 are set in the control unit 4; a button circuit 45 is connected between the micro-processing chip 41 and the mode switch button 81, the high temperature switch 82 and the thermoregulation/time regulation buttons 91, 92; the high-power drive circuit 43 is connected between the micro-processing chip 41 and the heating members 11, 21, and is connected to a DC output terminal of the commutated voltage transformation circuit 51, said temperature sensing member 42 is connected to the micro-processing chip 41; the display driver circuit 44 is connected between the display device 6 and the micro-processing chip 41. A sound circuit 46 is connected between the micro-processing chip 41 and a buzzer.

The members work together in harmony under the control of the micro-processing chip 41 based on the programmed process, the work flow will be explained hereinafter.

When the machine is in power state, the display device 6 displays “---”, press the power switch 93, the display device 6 displays “155”, this means that the temperature value is set as 155° C., press the thermoregulation/time regulation buttons 91, 92 to regulate temperature, there are some temperature grades: 155, 180, 205, 230, when the temperature is adjusted, press the thermoregulation/time regulation buttons 91, 92 in the countdown process, the showed temperature value or time value will change accordingly, and the countdown process will be re-started; press the power switch 93, the machine is shut down, the display device 6 displays “---”.

When the temperature sensing member 42 senses that the temperature of the grill pan reaches the set value, the heating members 11, 21 is disconnected from a power, when the temperature of the grill pan is lower than the set temperature value, the heating members 11, 21 is connected with a power till the temperature of the grill pan reaches the set value, this cycle continues till time reaches the set time value. If no button is pressed, the machine is shut down after 1 hour, the display device 6 displays “---”.

After pressing the high temperature switch 82, the display device 6 displays 260, this means that the temperature of the high temperature switch 82 is set as 260° C., the buzzer will not make a buzzing sound until the temperature of the grill pan reach said set value, at this time put food into grill, the duration is 2 minutes. In this embodiment, the temperature of the high temperature switch is set as 260° C., the duration is 2 minutes, but no limit by these, the temperature of the high temperature switch can be set as any temperature between 245° C. and 275° C., the duration can be set as any time, which is more than 1 minute, so as to grill the surface of food at high temperature. We can press the mode switch button 81 to change to time regulation state, the display device 6 displays “5”, this means that the duration is set as 5 minutes. Press time regulation button 92, add or subtract 1 minute each time, the regulation range is 1, 2, 3, . . . , 19, 20, 1, and cycle in turn. We can press the mode switch button 81 to change to temperature regulation state, the display device 6 displays “205” , this means that the temperature is set as 205° C. Press the thermoregulation button 91, add or subtract 1° C. each time. After the setting is completed, the countdown process will be started, the display device 6 displays the set temperature value and blinking, when reaching the set time value, the temperature value stop blinking, and the buzzer makes a buzzing sound. At this time the display and setting go back to the state before pressing the high temperature switch 82. The time setting has memory function, the time value set in last time will be displayed in next grilling.

Thus, the work flow of said grill meets the requirement that firstly grill at high temperature then grill at low temperature, in order to cook flesh food whose surface is slightly burned and the interior is full of gravy, and the operation is convenience to users, users can press the high temperature switch 82 to obtain this function.

As mentioned above, the described embodiments are to be considered in all respects only as illustrative and no restrictive. All changes which come within the meaning and range of equivalency of the claims are to be embraced with their scope.

### INDUSTRY PRACTICABILITY

The Adjustable temperature electrothermal grill based on the present invention, provided with a temperature sensing member for sensing temperature of the grill pan, the temperature and the holding time can be regulated according to requirement, for cooking flesh food whose surface is slightly burned and the interior is full of gravy; the present invention is designed rationally, and easy to operate, has good industrial practicality.

1. A grill comprises: a grill pan provided with a heating member for heating said grill pan;
a control circuit;
a temperature sensing member for sensing temperature of the grill pan and providing the temperature signal of said grill pan to said control circuit;
wherein said heating member and said temperature sensing member are connected to said control circuit;
a thermoregulation member and a high temperature switch for providing the temperature control signal to said control circuit; wherein said control circuit controls the power on/off of said heating member based on the temperature signal of the grill pan and the temperature control signal.

2. The grill according to claim 1, wherein the temperature of the grill pan can reach any temperature between 245° C. and 275° C. based on the temperature control signal provided by said high temperature switch.

3. The grill according to claim 2, wherein the temperature of the grill pan can reach 260° C. based on the temperature control signal provided by said high temperature switch.

4. The grill according to claim 1, wherein the duration for heating the grill pan based on the temperature control signal provided by said high temperature switch is 2 minutes.

5. The grill according to claim 1, wherein the grill further comprising a time regulation button for providing time control signal to said control circuit.

6. The grill according to claim 1, wherein said control circuit comprises a power supply unit and a control unit; a commutated voltage transformation circuit disposed on said power supply unit for providing the DC current to the control unit and said heating member; said control unit comprising a micro-processing chip, a button circuit and a high-power drive circuit; said button circuit is connected between said micro-processing chip and said thermoregulation member and the high temperature switch; said high-power drive circuit is connected between said micro-processing chip and said heating member and is connected to a DC output terminal of the commutated voltage transformation circuit, said temperature sensing member is connected to the micro-processing chip.

7. The grill according to claim 6, wherein the grill further comprising a display device; a display driver circuit is set in said control unit; said display driver circuit is connected between the display device and the micro-processing chip.

8. The grill according to claim 1, wherein the grill further comprising a mode switch button for switching the temperature value or timing value displayed on the display device.

9-11. (canceled)
